(19) United States
(12) Patent Application Publication
(10) Pub. No.: US 2016/0039268 A1
(43) Pub. Date: Feb. 11, 2016

(54) HVAC AUXILIARY DUCT ATTACHMENT

(71) Applicant: DENSO International America, Inc., Southfield, MI (US)

(72) Inventors: Delomer Gosioco, Royal Oak, MI (US); Brian Belanger, Farmington Hills, MI (US)

(21) Appl. No.: 14/456,494

(22) Filed: Aug. 11, 2014

(51) Int. Cl. B60H 1/24; B60H 1/34

(52) U.S. Cl. CPC B60H 1/243; B60H 1/34

(57) ABSTRACT

An HVAC system is provided for use in a vehicle. The HVAC system includes a HVAC housing having a duct opening formed in a wall. An auxiliary duct may be inserted into the opening formed in the wall to direct air to a specified location. The opening may form a flap that contacts the auxiliary duct and is held in place adjacent to the wall by the contact of the auxiliary duct. The location can of the duct opening can be anywhere along the HVAC housing or any ducts leading off the HVAC.

### FIELD

The present disclosure relates to heating, ventilating, and air-conditioning (HVAC) systems in vehicles and, more particularly, relates to an auxiliary duct attachment.

### BACKGROUND

This section provides background information related to the present disclosure which is not necessarily prior art.

The present disclosure relates generally to automotive vehicle climate control HVAC systems, it is common to have a climate control system located within an instrument panel which provides heated or cooled air to occupants through dash panel defrost air outlets, instrument panel venting air outlets and floor directed air outlets. Some vehicles, depending on option level, may require different areas of the vehicle to be heated or cooled by an auxiliary duct. The auxiliary duct may direct climate controlled air to a beverage cooler or heater, dashboard compartment for beverages, passenger space, passenger seat, or electronics by way of non-limiting example. Additionally, modern vehicles and assembly techniques are driving toward commonality and adaptability with many components to allow different features and upgrades to be easily added to higher option vehicles without adding cost or complexity to manufacturing facilities.

### SUMMARY

This section provides a general summary of the disclosure, and is not a comprehensive disclosure of its full scope or all of its features.

A embodiment may be an HVAC system that has a housing which also may have a case wall. The case wall may have an inside surface and an exterior surface. The wall may also have a duct opening formed in it. The duct opening may form a flap, the flap may be coupled to the case wall by a living hinge. A auxiliary duct may be inserted into the duct opening and contacts the flap and holds the flap adjacent to the inside surface of the case wall.

An additional embodiment may be a duct that has a wall. The wall may have an inside surface and an outside surface. The wall may also contain an opening through the wall. A flap, that has a living hinge, may be connected to the wall by the living hinge. An auxiliary duct may be inserted inside the opening, the auxiliary duct may make contact to a flat portion of the flap causing the flap to be held adjacent to the inside surface of the wall.

An additional embodiment may be a vehicle HVAC system that has an HVAC housing. The housing may also contain a duct opening formed in a wall, the wall may have an inside surface and an outside surface. The HVAC housing may also have a evaporator which has a upstream side and a downstream side. The HVAC housing may also have a blower located upstream of the evaporator; and a heater core located downstream of the evaporator. Further downstream of the heater core may be a plurality of ducts. The HVAC housing may also contain a flap that is connected to the inside surface of the wall by a living hinge, the living hinge may be a part of the duct opening. Also the system may have an auxiliary duct which may be inserted inside the duct opening with a portion of the auxiliary duct located inside the HVAC housing. The portion of the auxiliary duct that may be located inside the housing may have a cross-sectional shape that is generally triangular. Additionally, the flap may have a flat portion adjacent to the living hinge and an angled portion that is opposite the living hinge. The flat portion of the flap may abut against the auxiliary duct and which may hold the flap adjacent to the inside surface of the wall.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The drawings described herein are for illustrative purposes only of selected embodiments and not all possible implementations, and are not intended to limit the scope of the present disclosure.

FIG. 1 is a schematic representation of a vehicle having a HVAC system;

FIG. 2 is a representation the passenger space of the vehicle;

FIG. 3 is a block diagram of the HVAC system;

FIG. 4A is side view of the auxiliary duct;

FIG. 4B is a front view of the auxiliary duct;

FIG. 5A is a side cross section view of the HVAC case wall;

FIG. 5B is a front view of the HVAC case wall;

FIG. 6 is a view of the auxiliary duct being assembled;

FIG. 7 is a view of the assembly;

FIG. 8A is a view of the locking feature;

FIG. 8B is a view of another embodiment locking feature;

FIG. 9A is another embodiment of the auxiliary duct;

FIG. 9B is another embodiment of the auxiliary duct; and

FIG. 9C is yet another embodiment of the auxiliary duct.

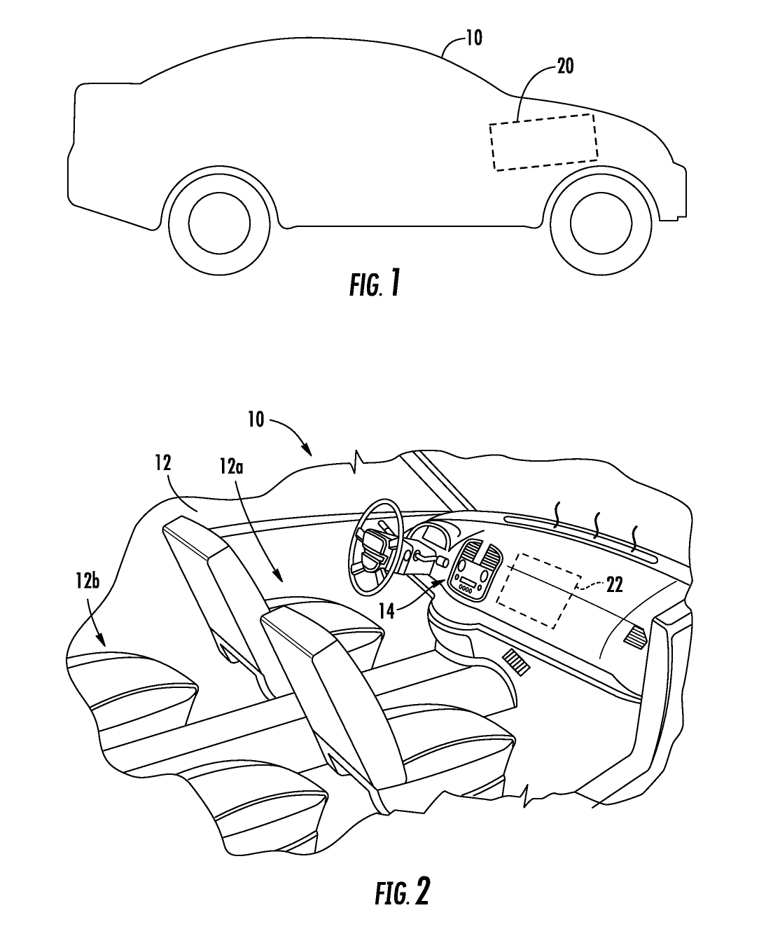

Corresponding reference numerals indicate corresponding parts throughout the several views of the drawings.

### DETAILED DESCRIPTION

Example embodiments will now be described more fully with reference to the accompanying drawings. The following description is merely exemplary in nature and is not intended to limit the present disclosure, application, or uses. It should be understood that throughout the drawings, corresponding reference numerals indicate like or corresponding parts and features.

Referring to FIGS. 1 & 2, an automotive vehicle 10 with an HVAC system 20 within which an HVAC module 22 according to the present teachings can be utilized is shown. Vehicle 10 includes a passenger compartment 12 which may have both a front passenger compartment 12a and a rear passenger compartment 12b. HVAC controls 14 allow adjustment of the operation of HVAC module 22 to provide desired flows of conditioned air.

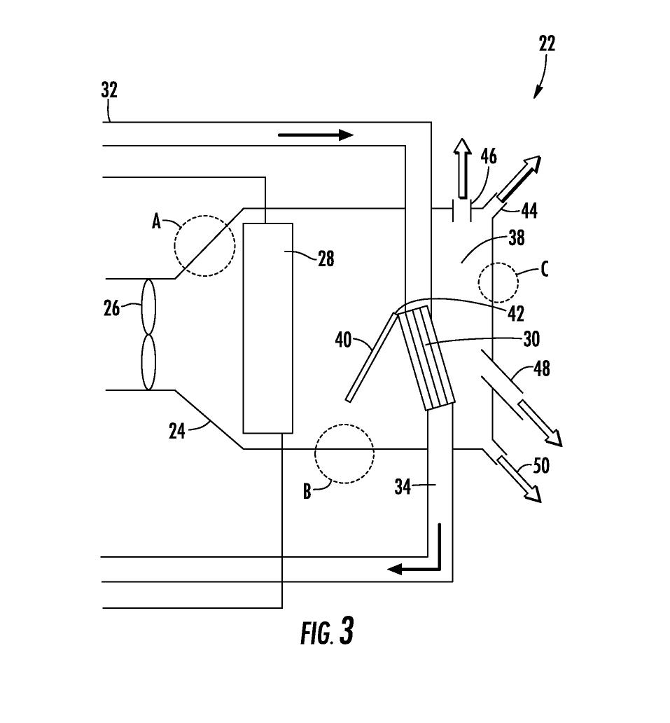

With reference to FIG. 3, a block diagram of a conventional vehicle HVAC module 22 is shown. An HVAC case 24 forms a ventilation duct through which air conditioned and/or heated air is sent into the passenger compartment 12. The HVAC case 24 contains a fan, or known in the art as a blower 26, which is arranged on the upstream side of an evaporator 28. Low pressure refrigerant flowing into the evaporator 28 absorbs heat from the air inside the HVAC case 24 for evaporation. The HVAC case 24 accommodates, on the downstream side of the evaporator 28, a hot water heater core 30 (heat exchanger). The heater core 30 includes an inlet pipe 32 and an outlet pipe 34. Hot water (coolant) of the vehicle engine (not shown) is directed to the heater core 30 through the inlet pipe 32 by a water pump (not shown).

An air bypass channel 38 is formed beside the heater core 30. An air distribution door 40 is provided to adjust the volume ratio between warm air and cool air that passes through the hot water heater core 30 and the bypass channel 38, respectively. The air distribution door 40 adjusts the temperature of the air blown into the passenger compartment 12 by adjusting the volume ratio between the warm air and the cool air. The door rotates on an axis 42 to adjust the volume ratio.

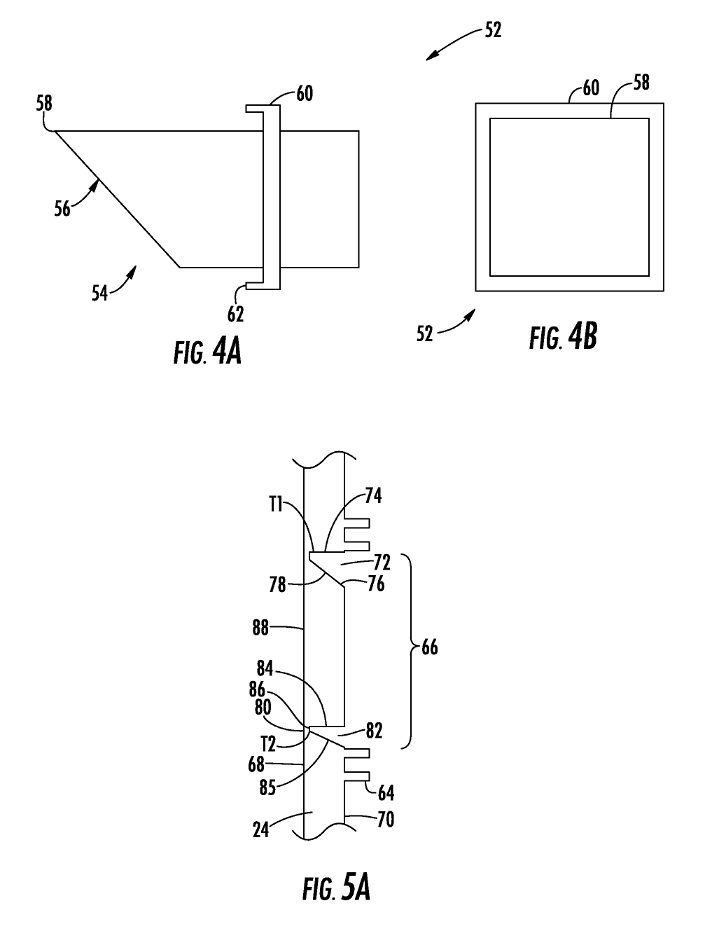

Additionally, the HVAC case 24 may have a plurality of ducts that lead to a face outlet 44, a defroster outlet 46, a foot outlet 48 and a rear cabin compartment outlet 50. The face outlet 44 directs air toward the upper body portions of passengers, the defroster outlet 46 directs air toward the internal surface of a windshield, the foot outlet 48 directs air toward the feet of the front seat passengers, and the rear cabin outlet 50 directs air toward the rear passenger compartment 12b of the vehicle 10. The outlets 44, 46, 48, 50 are opened and closed by outlet mode doors (not shown). An auxiliary duct 52, shown in detail in FIG. 4A & 4B, may be placed anywhere on the HVAC case 24. If non-conditioned airflow is desired; the auxiliary duct may be placed downstream of the blower 26 and upstream of the evaporator 28 in a location similar to circle A in FIG. 3, as a non-limiting example. If cool air is desired; the auxiliary duct 52 may be placed in a location between the evaporator 28 and heater core 30, this location represented by circle B as a non-limiting example. It may also be desired to provide heated or cooled air, depending on the user settings of the HVAC system 20. If so desired, the auxiliary duct 52 may be placed in a location represented by circle C of the HVAC case 24. It can also be appreciated by someone skilled in the art that the auxiliary duct 52 may be placed anywhere on the HVAC case 24 or on any duct or hollow vessel leading out of the HVAC case 24.

Referring to FIG. 4A which shows a side view of an auxiliary duct 52, specifically the portion of the auxiliary duct 52 that may be connected to an HVAC case 24 or any other portion of another duct (not shown). The end 54 of the auxiliary duct 52 has a generally triangular shape portion 56 of the cross-sectional side view; this triangular shape forms a piercing edge 58. The auxiliary duct 52 may also include a locking portion 60; this locking portion 60 may include a tongue portion 62 that may engage a structure on the HVAC case 24. The locking portion 60 may surround the perimeter of the auxiliary duct 52; it may act as a seal to prevent air leakage when connected to the HVAC case 24, it may also act as a positive stop during the assembly process. FIG. 4B shows a front view of the auxiliary duct 52, in this embodiment the auxiliary duct 52 is square shaped, however it can be understood in the art that the auxiliary duct 52 can be any suitable shape.

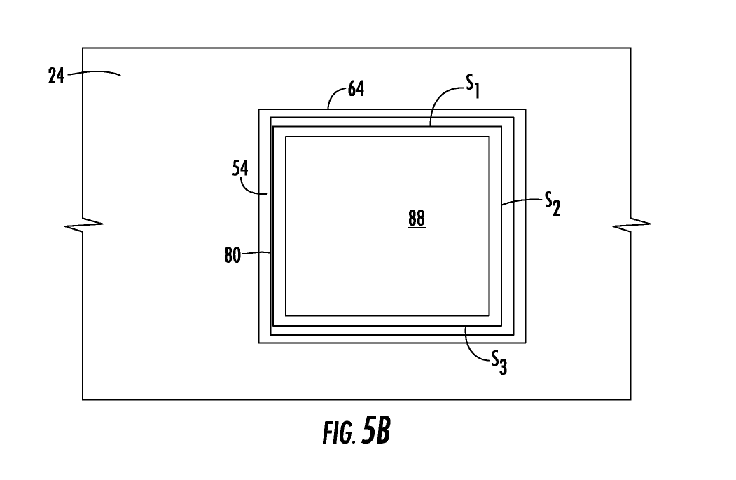

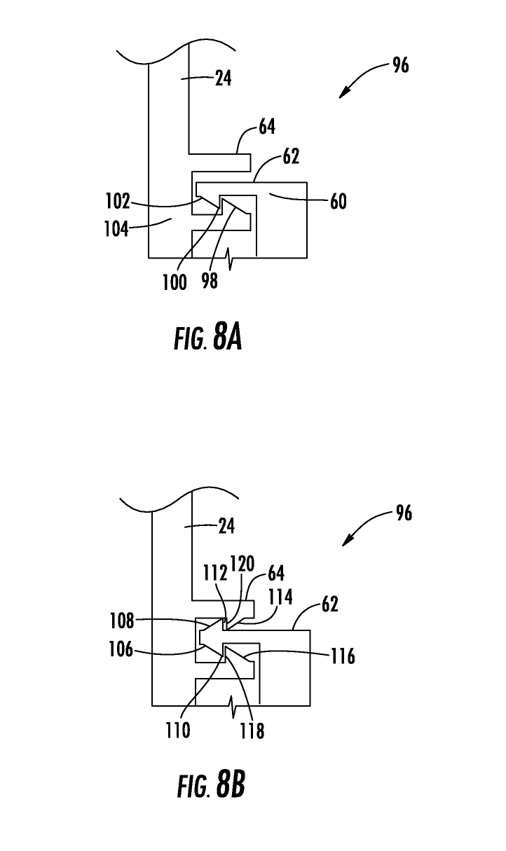

The corresponding connection to the auxiliary duct 52 on the HVAC case 24 is illustrated in FIGS. 5A and 5B. Referring to FIG. 5A, a cross-section view of the HVAC case 24 is displayed, which may be located at any of the circles referenced in FIG. 3 or any other desired location along any other duct or a hollow vessel. The HVAC case 24 may contain a groove section 64 that may engage the tongue portion 62 of the auxiliary duct 52. The tongue portion 62 may be inserted into the groove section 64 to create a snap or locking feature 96 (shown in FIG. 8). This locking feature 96 may, when fully assembled, attach or securely fix together the auxiliary duct 52 to the case wall 24. The groove section 64 may surround the entire auxiliary duct opening area 66, which generally matches the shape of the locking portion 60 surrounding the perimeter of the auxiliary duct 52. The HVAC case 24 may have an inner surface 68 and may have an outer or exterior surface 70. The HVAC case 24 may also contain a weakened portion 72. The weakened portion 72 may be a molded triangular shape with a first edge 74 perpendicular to the outer surface 70, the opening 76 of the weakened portion is substantially parallel with the outer surface 70. An angled edge 78 completes the triangular shape of the weakened portion 72. It may be appreciated that the weakened portion 72 does not fully extend through the HVAC case 24, a thickness T1 of the HVAC case 24 remains. This thickness T1 remains so the HVAC case 24 may be used in applications where an auxiliary duct 52 is not needed and have sufficient strength to last the life of the vehicle 10. The HVAC case 24 may also have a hinge portion 80. The hinge portion 80 may be created in the HVAC case 24 by molding or forming a trapezoidal shape 82 in the HVAC case 24. The trapezoidal shape 82 may contain a first edge 84 that may be substantially flat and perpendicular to the outer surface 70, the opening of the hinge portion 80 is substantially parallel with the outer surface 70, additionally the top edge 86 may be parallel with the outer surface 70. An angled edge 85 of the trapezoid shape 82 hinge portion 80 extends from the top edge 86 toward the groove section 64. The trapezoid shape 82 does not extend through the entire thickness of the HVAC case, a thickness T2 of the HVAC case 24 remains to act as a living hinge as part of the hinge portion 80. Additionally, thickness T2 is thick enough to keep the flap 88 attached to the HVAC case 24, throughout the life of the vehicle 10. It is appreciated that in the current square shape embodiment the weakened portion 72 would make up three sides to the square shape and the hinge portion only one side of the square. This is illustrated in FIG. 5B, which is a front view of the corresponding connection to the auxiliary duct 52 on the HVAC case 24. Sides S1, S2, S3 may contain the shaped of the weakened portion 72, whereas the fourth side S4 may contain the hinge portion 80. The four sides complete a square flap 88. The groove section 64 may completely surrounds the perimeter of the square flap 88.

Assembling the auxiliary duct 52 to the HVAC case 24 is shown in FIG. 6. The auxiliary duct 52 is forced toward the HVAC case 24, specifically toward the outside surface 70, in the direction as shown by arrow 90. The piercing edge 58 of the auxiliary duct may be aligned with one of the sides of the HVAC case 24 with the weakened portion 72 opposite the hinge portion 80. As the piercing edge 58 makes contact with the weakened portion 72, the weakened portion 72 will break or fracture. As the auxiliary duct 52 is further inserted into the HVAC case 24 the additional sides of the flap 88 that contained the weakened portion 72 will also break or fracture and the flap 88 will start to rotate around the hinge portion 80 which acts as a living hinge, as displayed by the dotted lines in FIG. 6.

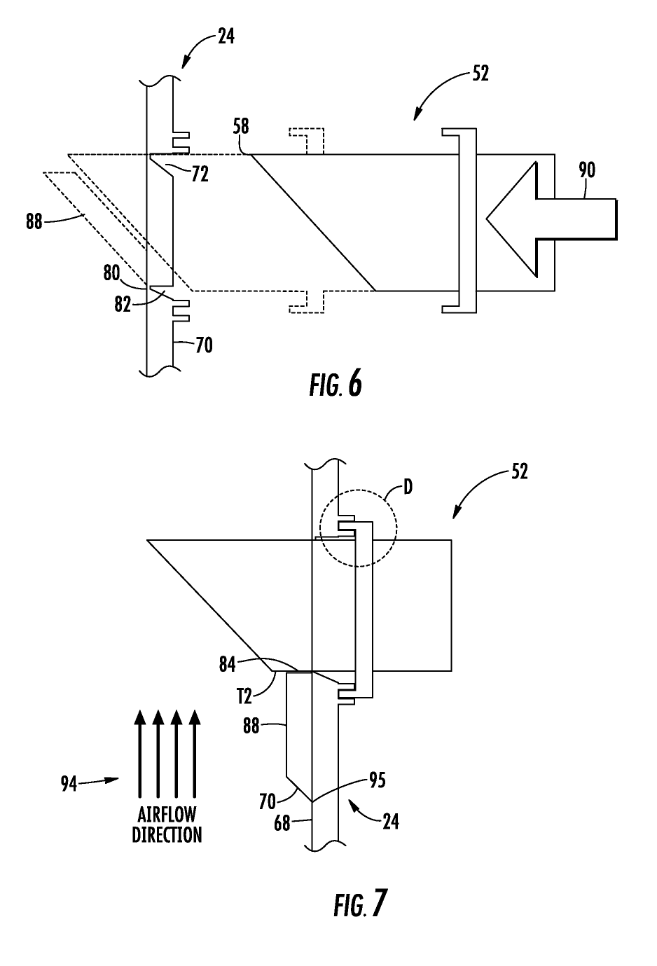

The fully assembled auxiliary duct 52 and HVAC case 24 is illustrated in FIG. 7. When fully assembled the orientation and shape of the hinge portion 80 and weakened portion 72 may be appreciated. When fully assembled the bottom surface 92 of the auxiliary duct 52, which is the opposite side of the piercing edge 58, may come into contact with the first edge 84 of the trapezoid shape 82 formed into the HVAC case 24. This contact or abutment may allow the flap 88 to be completely folded over and parallel and adjacent to the inside surface 68 of the HVAC case 24. This contact also may act as a hard stop to keep the flap 88 stationary during operation of the HVAC module 22, specifically when airflow, represented by arrows 94, passes over the flap 88. If the flap 88 is allowed to move during operation it may vibrate or create a noise that may be heard in the vehicle 10, or may cause a restriction in airflow 94 and reduce overall HVAC system 20 performance. It can also be appreciated the molded orientation of the weakened portion 72 triangular shape 76. When the auxiliary duct 52 may be fully inserted and the flap 88 may be completely folded over; the angle edge 78 then may act as an angled lead-in to the auxiliary duct 52, the point 95 of the angle edge points into and opposite the airflow 94. This may reduce some noise, vibration, or performance issues with having the flap 88 within the airflow 94 stream. Additionally the triangular portion 56 of the end 54 of the auxiliary duct 52 can be appreciated when fully assembled. In combination with the angled edge 78 and the triangular portion 56, the assembly may reduce airflow restrictions and may maximize amount of air distributed to the auxiliary duct 52 while limiting any noise or vibration concerns.

FIG. 8A is a close up of the circle D from FIG. 7, which shows an embodiment of the tongue 62 and groove 64 locking feature 96. The groove 64 may contain on one side a ramp 98 which is an angled portion, adjacent to the ramp 98 is a flat portion 100. The tongue may also have a ramp 102 and a flat portion 104. During insertion of the auxiliary duct 24 the tongue ramp 102 and groove ramp 98 will make contact, the tongue 62 may flex or bend or the groove 64 may flex or bend until each flat portions 100, 104 are engaged and parallel, locking and affixing the two components together. FIG. 8B, is another embodiment of locking feature 96 wherein the tongue 62 may have two symmetrical ramp portions 106, 108 and may have flat portions 110, 112. The groove 64 may contain on both sides a ramp 114, 116 which is an angled portion, adjacent to the ramps 114, 116 may be flat portions 118, 120. With this embodiment the groove 62 may flex or bend until each of the flat portions of the grove 118, 120 are engaged and parallel to the tongue 62 flat portions 110, 112 locking the two components together. It is also understood in the art that any locking mechanism may be used to attach the auxiliary duct 52 to the HVAC case 24.

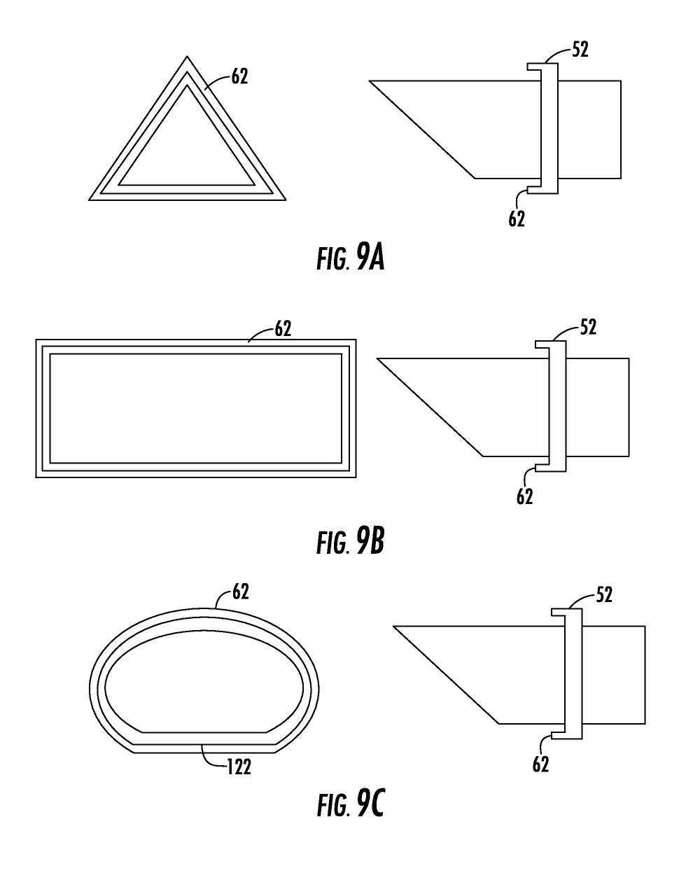

It can be appreciated that the duct shape may be any shape as illustrated in FIGS. 9A-9C. FIG. 9A shows that the duct may be triangular shape. FIG. 9B shows that the duct may be rectangular shape. FIG. 9C shows that the duct may be an oval or a circular shape, however it is understood that a flat portion 122 may be needed for a proper hinge portion 80.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An HVAC system comprising:
a HVAC housing having a case wall; the case wall having an inside surface and an exterior surface;
an duct opening formed in case wall;
a flap formed from said opening;
an auxiliary duct inserted into said duct opening; wherein the flap is coupled to the case wall by a living hinge and the flap is adjacent to the inside surface.

2. An HVAC system according to claim 1, wherein the flap has a flat portion adjacent to the living hinge and an angled portion opposite the flat portion.

3. An HVAC system according to claim 2, wherein the auxiliary duct abuts the flat portion of the flap.

4. An HVAC system according to claim 3, wherein a portion of the duct that is inserted into the duct opening is generally triangular in cross-sectional shape with a piercing edge, the piercing edge opposite the flat portion of the flap.

5. An HVAC system according to claim 1, wherein the auxiliary duct is fixed to the HVAC housing by a locking feature.

6. An HVAC system according to claim 4, wherein the locking feature further comprises a tongue portion that is affixed to the perimeter of the auxiliary duct; and
a groove portion that is affixed to the case wall outer surface around the perimeter of the duct opening, wherein the tongue portion is inserted into the groove portion.

7. An HVAC system according to claim 1, further comprising:
an evaporator located inside the HVAC housing;
a heater core located downstream of the evaporator; and
the duct opening located between the evaporator and heater core.

8. A duct comprising:
a wall; the wall having an inside surface and an outside surface;
an opening through the wall, a portion of the opening having a living hinge connecting to a flap;
a flat portion of the flap that is adjacent to the living hinge; and
an auxiliary duct inside the opening; wherein the auxiliary duct contacts the flat portion of the flap and the flap is adjacent to the inside surface of the wall.

9. A duct according to claim 8, wherein a portion of the auxiliary duct is located inside the wall and has a cross-sectional shape that is generally triangular.

10. A duct according to claim 8, further comprising; the flat portion of the flap is adjacent to the living hinge and an angled portion opposite the flat portion.

11. An duct according to claim 8, further comprising; a tongue portion that is affixed to the perimeter of the auxiliary duct; and
a groove portion that is affixed to the outside surface of the wall around the opening, wherein the tongue portion is inserted into the groove portion.

12. A vehicle HVAC system comprising:
a HVAC housing having a duct opening formed in a wall, the wall having an inside surface and an outside surface;
an evaporator having a upstream side and a downstream side;
a blower located upstream of the evaporator;
a heater core located downstream of the evaporator;
a plurality of ducts located downstream of the heater core;
a flap connected to the inside surface of the wall by a living hinge, the living hinge being part of the duct opening; and
an auxiliary duct inserted inside the duct opening with a portion of the auxiliary duct located inside the HVAC housing that has a cross-sectional shape that is generally triangular, wherein the flap has a flat portion adjacent to the living hinge and an angled portion opposite the flat portion, the flat portion of the flap abutting against the auxiliary duct and the flap is adjacent to the inside surface of the wall.

13. A vehicle HVAC system according to claim 12, further comprising; a tongue portion that is affixed to the perimeter of the auxiliary duct; and
a groove portion that is affixed to the outside surface of the wall around the opening, wherein the tongue portion is inserted into the groove portion.

14. A vehicle HVAC system according to claim 12, wherein the duct opening is located between the evaporator and heater core.

15. A vehicle HVAC system according to claim 12, wherein the duct opening is located downstream of the heater core.

16. A vehicle HVAC system according to claim 12, wherein the duct opening is upstream of the evaporator.
